(19) United States
(12) Patent Application Publication
(10) Pub. No.: US 2020/0243950 A1
(43) Pub. Date: Jul. 30, 2020

(54) APPARATUS AND METHODS FOR ATTACHING EQUIPMENT TO A POLE

(71) Applicants: Jan M. Goldfluss, Ridgefield, CT (US); Rodney Barnes, Groveland, FL (US); Lewis James Burrows, Fairfield, CA (US)

(72) Inventors: Jan M. Goldfluss, Ridgefield, CT (US); Rodney Barnes, Groveland, FL (US); Lewis James Burrows, Fairfield, CA (US)

(21) Appl. No.: 16/261,085

(22) Filed: Jan. 29, 2019

(51) Int. Cl. H01Q 1/24

(52) U.S. Cl. CPC H01Q 1/246

(57) ABSTRACT

An apparatus for attaching equipment to a pole includes a plurality of pole-attaching brackets, a support member, and a plurality of U-shaped, longitudinally-extending members. The support member is connected with and between the plurality of pole-attaching brackets. The support member is adjustable towards and away from the plurality of pole-attaching brackets. The plurality of U-shaped, longitudinally-extending members are attached to the support member. Opposed ends of each U-shaped, longitudinally-extending member curve inwardly.

### FIELD OF THE DISCLOSURE

This disclosure relates to apparatus and methods for attaching equipment to a pole extending from the ground.

### BACKGROUND

Poles attached to the ground are often used to support equipment and antennas off the ground in urban and rural environments. These poles, typically owned by public utility companies and/or municipalities, are strictly regulated and demand conformance to specific mounting regulations. A variety of apparatus are used to attach the equipment and antennas to the poles. These apparatus typically are limited in how the equipment may be configured and/or positioned relative to the pole, and expose the equipment and/or wiring to the equipment which is not aesthetically pleasing. Often such apparatus require extensive customized shop fabrication and timely installation on-site which increases cost. Other such apparatus may have additional issues.

An apparatus and method is needed to reduce or eliminate one or more of the issues associated with current apparatus and methods for attaching equipment to poles.

### SUMMARY

In one embodiment, an apparatus for attaching equipment to a pole is disclosed. The apparatus includes a plurality of pole-attaching brackets, a support member, and a plurality of U-shaped, longitudinally-extending members. The support member is connected with and between the plurality of pole-attaching brackets. The support member is adjustable towards and away from the plurality of pole-attaching brackets. The plurality of U-shaped, longitudinally-extending members are attached to the support member. Opposed ends of each U-shaped, longitudinally-extending member curve inwardly.

In another embodiment, an apparatus for attaching equipment to a pole is disclosed. The apparatus includes a plurality of pole-attaching brackets and a shroud. The shroud is connected with the plurality of pole-attaching brackets. The shroud includes a first shroud member, a second shroud member, and a cavity. The first shroud member is fixedly attached with the plurality of pole-attaching brackets. The second shroud member is pivotally mounted with the plurality of pole-attaching brackets and configured to move between a closed position against the first shroud member and an open position disposed apart from the first shroud member. The cavity is disposed between the first and second shroud members.

In still another embodiment, a method of attaching or using an apparatus is disclosed. One step comprises attaching a plurality of pole-attaching brackets to a pole. Another step comprises adjusting the plurality of pole-attaching brackets laterally relative to the pole while attached to the pole. An additional step comprises adjusting a support member, connected with and between the plurality of pole-attaching brackets, towards and away from the plurality of pole-attaching brackets.

In yet another embodiment, a method of attaching or using an apparatus is disclosed. One step comprises attaching a plurality of pole-attaching brackets to a pole. Another step comprises fixedly attaching a first shroud member of a shroud with the plurality of pole-attaching brackets. An additional step comprises pivotally mounting a second shroud member with the plurality of pole-attaching brackets to form a cavity between the first and second shroud members.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates one embodiment of a front view of a pole having equipment and an antenna attached to the pole;

FIG. 2 illustrates a perspective view within rectangle 2-2 of FIG. 1 with the equipment and a shroud of an apparatus removed;

FIG. 3 illustrates a perspective view within rectangle 3-3 of FIG. 2;

FIG. 4 illustrates a side view of the view shown in FIG. 2;

FIG. 5 illustrates a top view of the view shown in FIG. 2;

FIG. 6 illustrates the view of FIG. 2 with the shroud of the apparatus attached and in a closed position;

FIG. 7 illustrates a side view of the view of FIG. 6;

FIG. 8 illustrates a top view of the view shown in FIG. 6;

FIG. 9 illustrates the view of FIG. 6 with the shroud of the apparatus attached and in an open position;

FIG. 10 illustrates a top view of the view shown in FIG. 9;

FIG. 11 illustrates a top view of the view shown in FIG. 6 with the equipment detached within the shroud of the apparatus to show how the equipment may be attached within the shroud;

FIG. 12 illustrates a flowchart of one embodiment of a method of attaching or using an apparatus; and

FIG. 13 illustrates a flowchart of one embodiment of a method of attaching or using an apparatus

### DETAILED DESCRIPTION

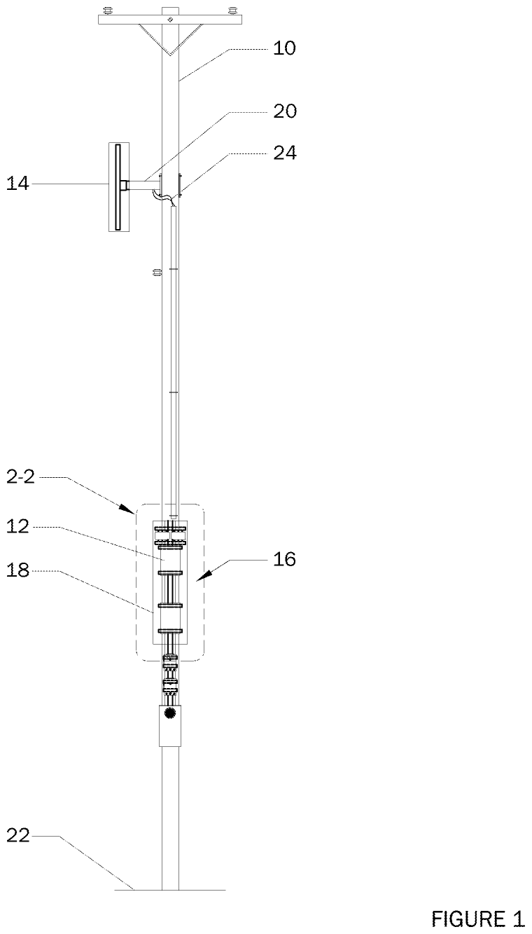

FIG. 1 illustrates one embodiment of a front view of a pole 10 having equipment 12 and an antenna 14 attached to the pole 10. An apparatus 16 attaches the equipment 12, within a shroud 18 of the apparatus 16, to the pole 10. A bracket 20 attaches the antenna 14 to the pole 10. The pole 10 may comprise a wood pole which may be attached to the ground 22 in an urban or rural environment. The equipment 12 may comprise equipment powering and/or connected to the antenna 14. The equipment 12 is wired to the antenna 14 using wiring 24. The antenna 14 may send out a wireless signal which can be received by cell-phones and other communication equipment.

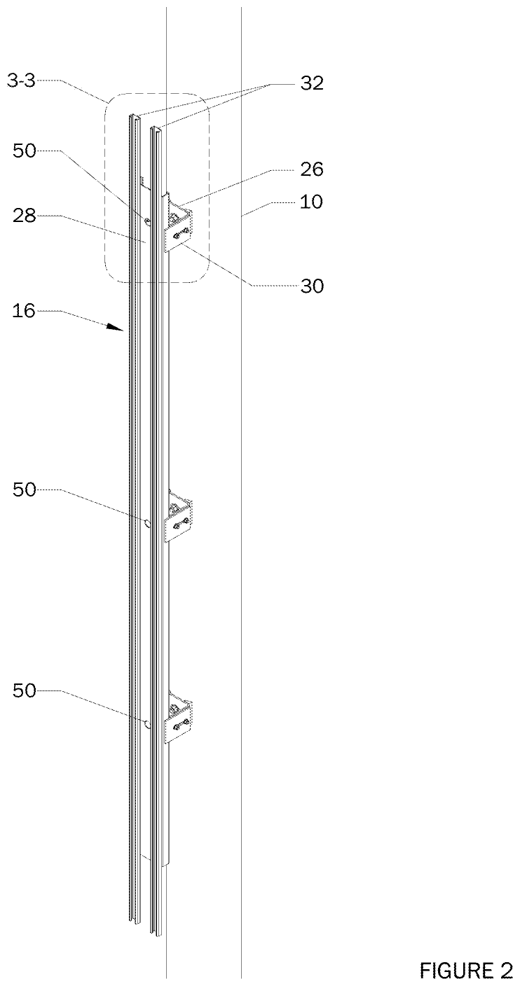

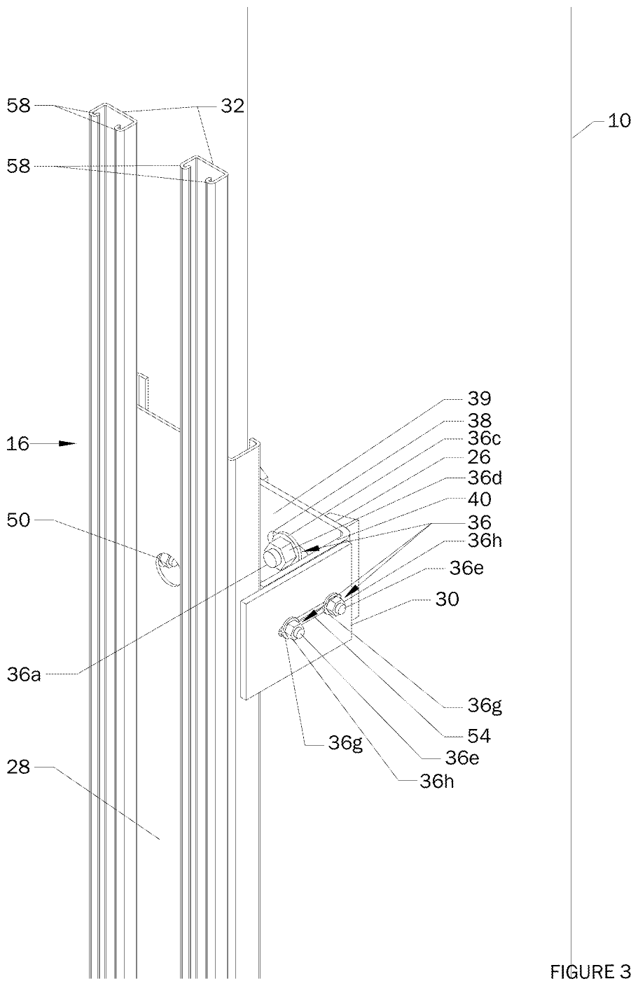

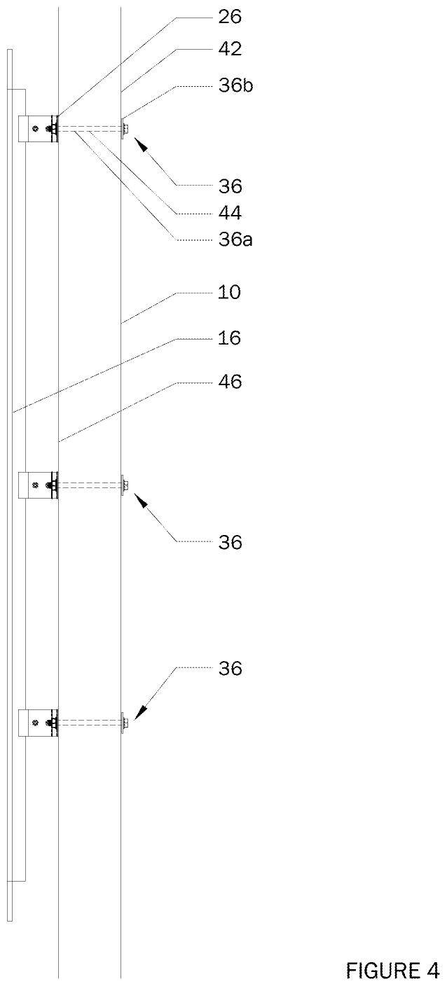

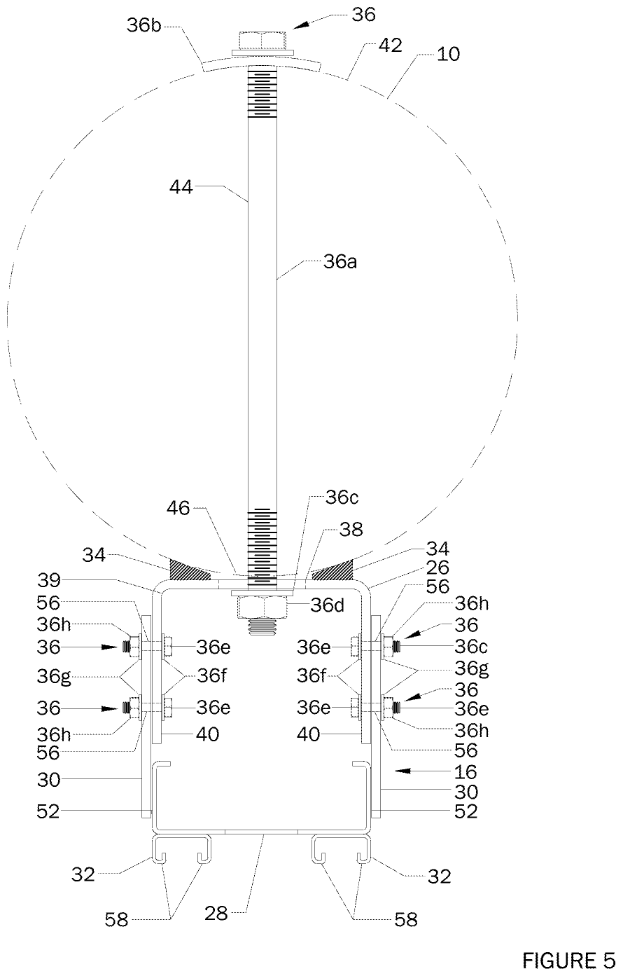

FIG. 2 illustrates a perspective view within rectangle 2-2 of FIG. 1 with the equipment 12 and shroud 18 of the apparatus 16 removed. FIG. 3 illustrates a perspective view within rectangle 3-3 of FIG. 2. FIG. 4 illustrates a side view of the view shown in FIG. 2. FIG. 5 illustrates a top view of the view shown in FIG. 2.

As shown in FIGS. 1-5 collectively, the apparatus 16 comprises a plurality of pole-attaching brackets 26, a support member 28, opposed members 30, a plurality of U-shaped, longitudinally-extending members 32, pads 34, and fastening devices 36. Each pole-attaching bracket 26 may comprise a U-shaped bracket having a slot 38 extending longitudinally in surface 39 between opposed surfaces 40 of the U-shaped bracket. Each pole-attaching bracket 26 is attached to the pole 10 with a bolt 36a which extends through a curved plate washer 36b disposed against one side 42 of the pole 10, through a hole 44 in the pole 10, out of side 46 of the pole 10, through the slot 38 of the pole-attaching bracket 26, through washer 36c, and is threadedly attached to nut 36d. Each pole-attaching bracket 26 may be adjusted side to side relative to the pole 10 by sliding the slot 38 of each pole-attaching bracket 26 relative to the bolt 36a in order to locate each pole-attaching bracket 26 laterally in the desired position relative to the pole 10. The nut 36d associated with each pole-attaching bracket 26 may then be tightened to its respective bolt 36a to fixedly attach the pole-attaching bracket 26 in the desired position relative to the pole 10.

Pads 34 may be disposed against both the pole 10 and surface 39 of each pole-attaching bracket 26 on opposite sides of the bolt 36a. The pads 34 may provide a cushioning surface and assist in preventing each pole-attaching bracket 26 from moving once the nut 36d associated with each pole-attaching bracket 26 is tightened to its respective bolt 36a. The pads 34 may be made of Neoprene or other materials.

The support member 28 may comprise a C-shape. The support member 28 may comprise a plurality of holes 50 disposed between the plurality of U-shaped, longitudinally-extending members 32. The plurality of holes 50 may be disposed in alignment with the slot 38 of each pole-attaching bracket 26. The plurality of holes 50 may allow a tool, such as a nut-attaching device, to be inserted through each hole 50 to attach the nut 36d to the bolt 36a when the bolt 36a is rotated relative to the nut 36d to secure each pole-attaching bracket 26 to the pole 10. The plurality of holes 50 may also be used to run the wiring 24 through the holes 50.

Two opposed members 30 may be welded, or attached using other methods, to opposite surfaces 52 of the support member 28 for each pole-attaching bracket 26. Each opposed member 30 may have a longitudinally-extending slot 54 disposed in alignment with a plurality of holes 56 of one of the opposed surfaces 40 of each respective pole-attaching bracket 26. Each pole-attaching bracket 26 is attached to each of the opposed members 30 with bolts 36e which extend through separate respective washers 36f, through the plurality of holes 56 in the respective opposed surface 40 of the respective pole-attaching bracket 26, through the respective longitudinally-extending slot 54 in the respective opposed member 30, through separate respective washers 36g, and which are threadedly attached to separate respective nuts 36h.

The support member 28 may be adjusted towards and away from the pole 10, in order to locate the support member 28 in the desired position relative to the pole 10, by sliding each respective longitudinally-extending slot 54 in the respective opposed member 30 relative to its respective bolts 36e passing through the plurality of holes 56 in the respective opposed surface 40 of the respective pole-attaching bracket 26. The nuts 36h associated with each opposed member 30 may then be tightened to their respective bolts 36e to fixedly attach the support member 28 in the desired towards and/or away position relative to the pole 10. In such manner, the support member 28 may be connected with and between the plurality of pole-attaching brackets 26 with the support member 28 being adjustable towards and away from the plurality of pole-attaching brackets 26.

The plurality of U-shaped, longitudinally-extending members 32 are welded in spaced-apart formation to the support member 28. In other embodiments, the plurality of U-shaped, longitudinally-extending members 32 may be attached to the support member 28 using varying methods. Opposed ends 58 of each U-shaped, longitudinally-extending member 32 curve inwardly. The plurality of U-shaped, longitudinally-extending members 32 may comprise off-the-shelf unistruts to which spring-nuts may be easily attached to, slid relative to and within, and detached from in order to attach the equipment 12 to the plurality of U-shaped, longitudinally-extending members 32. In other embodiments, the plurality of U-shaped, longitudinally-extending members 32 may vary.

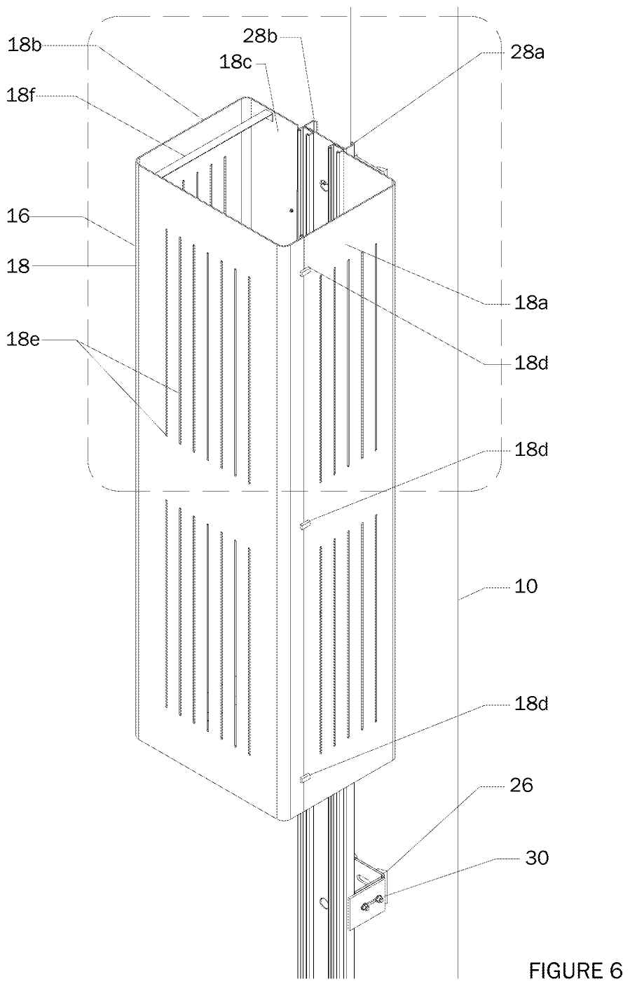

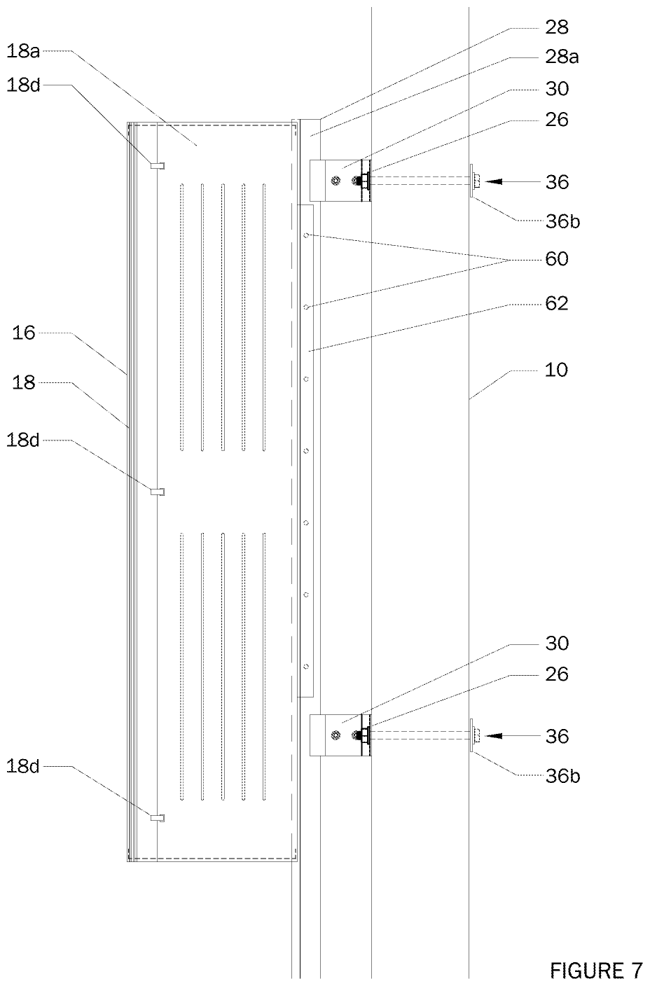

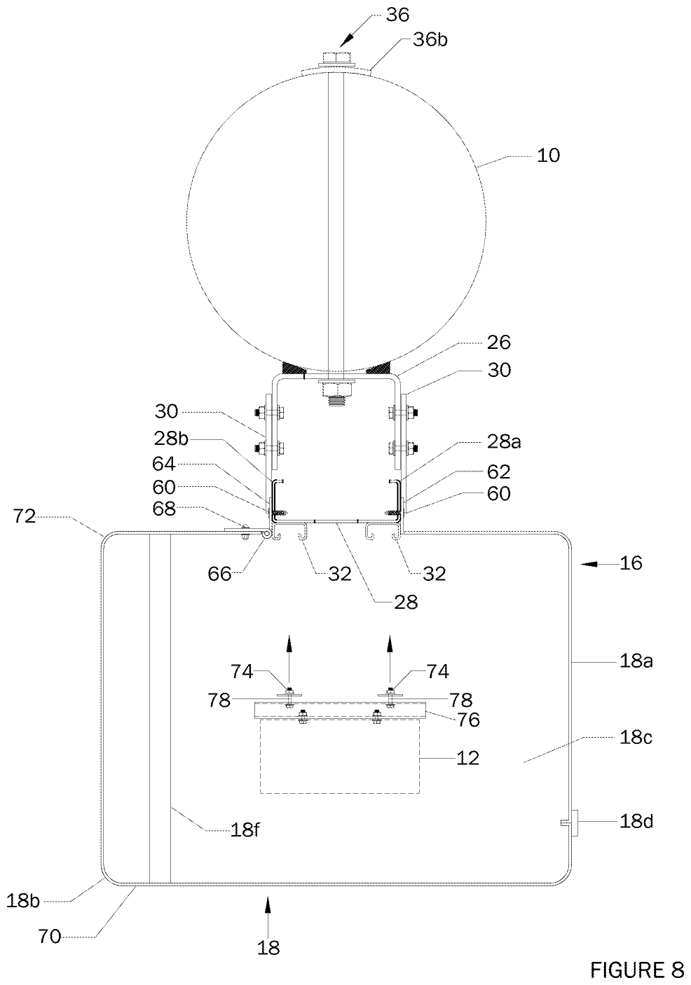

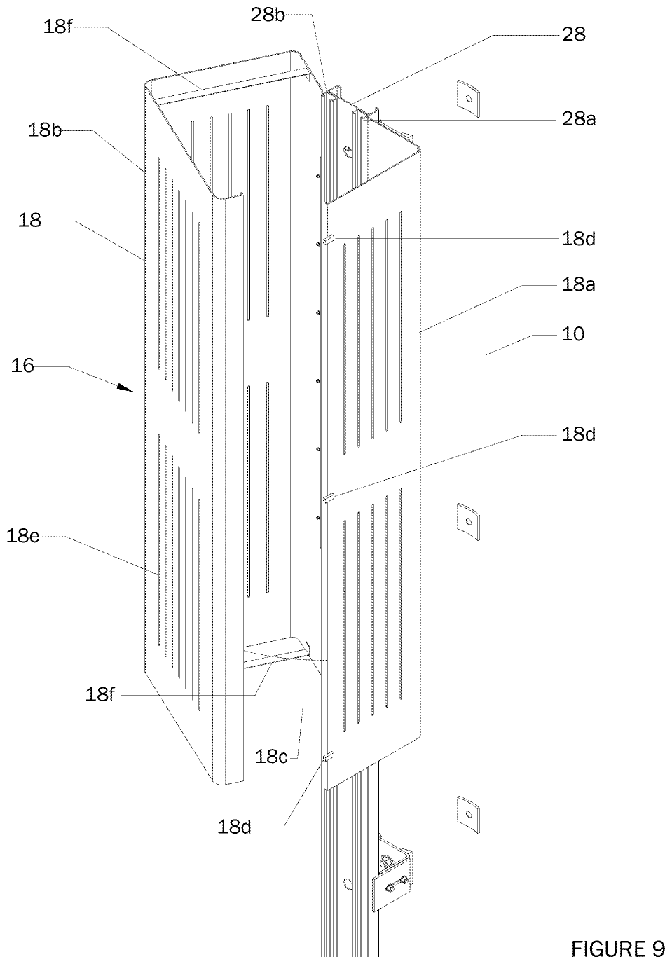

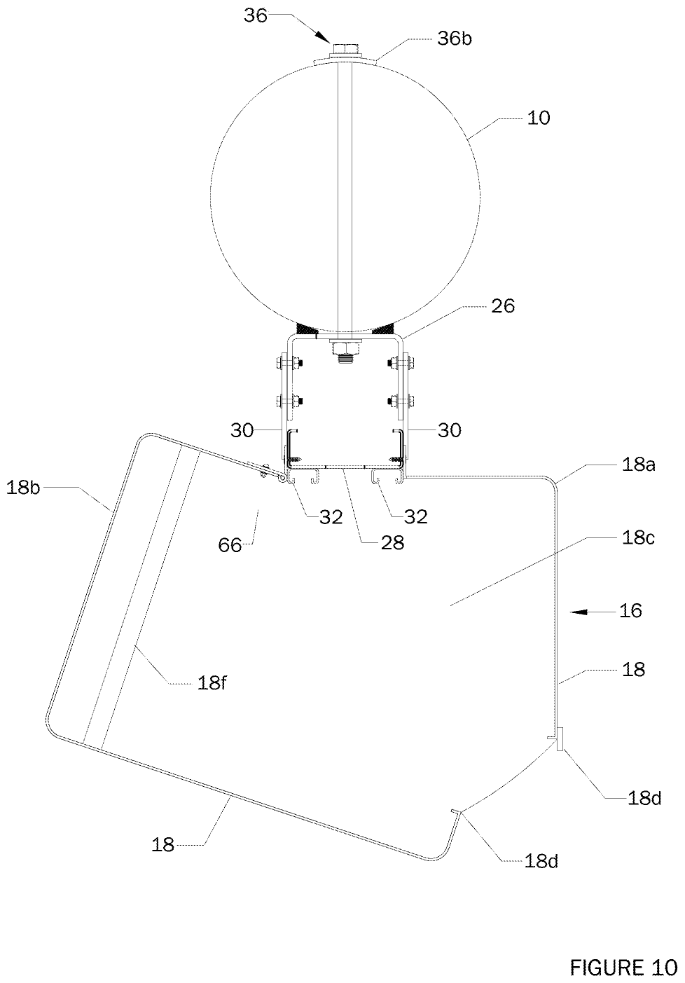

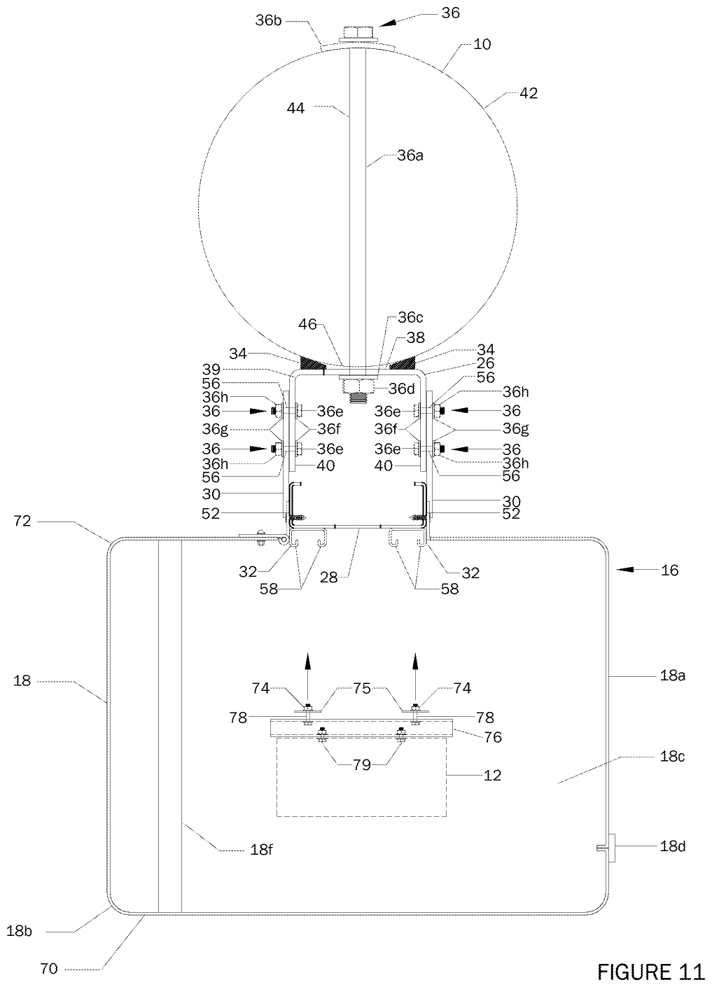

FIG. 6 illustrates the view of FIG. 2 with the shroud 18 of the apparatus 16 attached and in a closed position. FIG. 7 illustrates a side view of the view of FIG. 6. FIG. 8 illustrates a top view of the view shown in FIG. 6. FIG. 9 illustrates the view of FIG. 6 with the shroud 18 of the apparatus 16 attached and in an open position. FIG. 10 illustrates a top view of the view shown in FIG. 9. FIG. 11 illustrates a top view of the view shown in FIG. 6 with equipment 12 detached within the shroud 18 of the apparatus 16 to show how the equipment may be attached within the shroud 18 of the apparatus 16.

As shown in FIGS. 6-11 collectively, the shroud 18 comprises a first shroud member 18a, a second shroud member 18b, a cavity 18c, securement members 18d, a plurality of vents 18e, and stiffening member 18f The shroud 18 is connected to the support member 28 which is connected to the plurality of pole-attaching brackets 26 with the opposed members 30. The first shroud member 18a is fixedly attached to side 28a of the support member 28 with self-tapping screws 60 which extend through a flange 62 of the first shroud member 18a through side 28a of the support member 28. The second shroud member 18b is pivotally attached to side 28b of the support member 28 with self-tapping screws 60 which extend through a flange 64 of a piano hinge 66, attached to the second shroud member 18b with fastening element 68, through the side 28b of the support member 28. The cavity 18c is disposed between the first and second shroud members 18a and 18b. The stiffening member 18f is welded within the cavity 18c to and between opposed sides 70 and 72 of the second shroud member 18b. In other embodiments, the stiffening member 18f may be attached to the second shroud member 18b using varying methods.

The second shroud member 18b is configured to move between the closed position against the first shroud member 18a and the open position disposed apart from the first shroud member 18a. The securement members 18d are configured to fasten the second shroud member 18b to the first shroud member 18a to conceal equipment 12 disposed within the cavity 18c of the shroud 18. The securement members 18d may comprise clasps or other types of securement members. The plurality of vents 18e are disposed in both the first and second shroud members 18a and 18b. The plurality of vents 18e are configured to provide ventilation to the cavity 18c to provide ventilation to the equipment 12 once installed within the cavity 18c. The equipment 12 may be installed to the plurality of U-shaped, longitudinally-extending members 32 using nuts 74, washers 75, one or more rail members 76, bolts 78, and fasteners 79. The equipment 12 may be attached to the one or more rail members 76 using fasteners 79. The one or more rail members 76 may comprise one or more off-the-shelf unistruts. In other embodiments, the one or more rail members 76 may vary. The nuts 74 may be disposed in the U-shaped, longitudinally-extending members 32 with the bolts 78 extending through holes in the one or more rail members 76, through washers 75, and into the nuts 74 to attach the one or more rail members 76 to the U-shaped, longitudinally-extending members 32. In such manner, the equipment 12 may be attached within the cavity 18c of the shroud 18. In other embodiments, the equipment 12 may be attached within the cavity 18c of the shroud 18 using varying methods.

In other embodiments, one or more components of the apparatus 16 may be modified, one or more components of the apparatus 16 may not be present, or the apparatus 16 may be further modified.

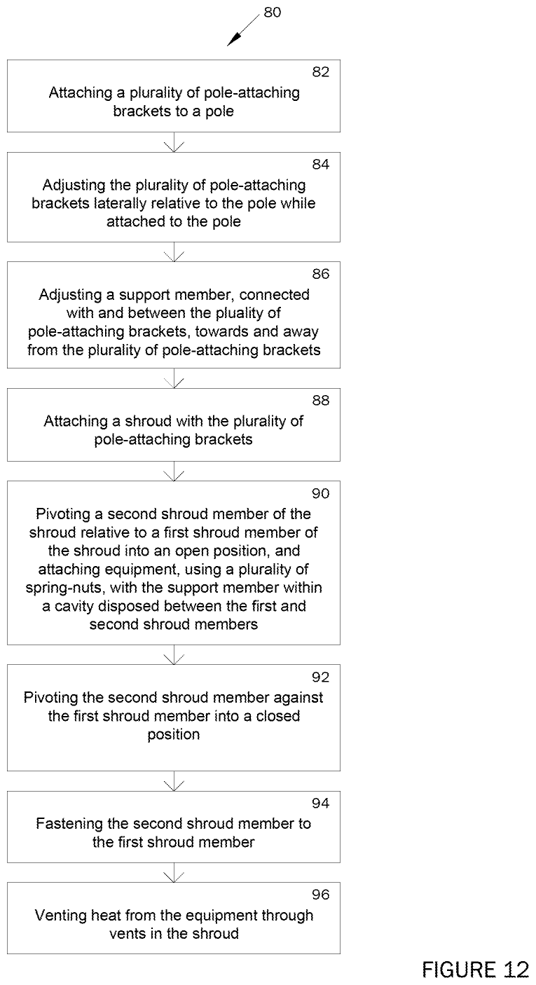

FIG. 12 illustrates a flowchart of one embodiment of a method 80 of attaching or using an apparatus. The method 80 may utilize any of the apparatus of the disclosure. In other embodiments, the method 80 may utilize varying apparatus. Step 82 comprises attaching a plurality of pole-attaching brackets to a pole. In one embodiment, step 82 comprises, for each of the plurality of pole-attaching brackets, inserting a fastener through a hole in the pole and through a longitudinally-extending slot in the pole-attaching bracket. Step 84 comprises adjusting the plurality of pole-attaching brackets laterally relative to the pole while attached to the pole. In one embodiment, step 84 comprises, for each of the plurality of pole-attaching brackets, sliding the longitudinally-extending slot along the fastener.

Step 86 comprises adjusting a support member, connected with and between the plurality of pole-attaching brackets, towards and away from the plurality of pole-attaching brackets. In one embodiment, step 86 comprises, for each of the pole-attaching brackets, inserting fasteners through longitudinally-extending slots in opposed members connected to the support member and through holes in the pole-attaching bracket, and sliding the longitudinally-extending slots along the fasteners.

Step 88 comprises attaching a shroud with the plurality of pole-attaching brackets. Step 90 comprises pivoting a second shroud member of the shroud relative to a first shroud member of the shroud into an open position, and attaching equipment, using a plurality of spring-nuts, with the support member within a cavity disposed between the first and second shroud members. In one embodiment, step 90 comprises attaching equipment with a plurality of U-shaped, longitudinally-extending members attached to the support member, wherein opposed ends of each U-shaped, longitudinally-extending member curve inwardly, using a plurality of spring-nuts. In another embodiment, step 90 further comprises adjusting a vertical position of the equipment along the U-shaped, longitudinally-extending members by compressing the plurality of spring-nuts, moving the equipment along the U-shaped, longitudinally-extending members, and extending the plurality of spring-nuts to reattach the equipment. In still another embodiment, step 90 further comprises extending an equipment wire through a hole in the support member. Step 92 comprises pivoting the second shroud member against the first shroud member into a closed position. Step 94 comprises fastening the second shroud member to the first shroud member. Step 96 comprises venting heat from the equipment through vents in the shroud.

In other embodiments, one or more steps of the method 80 may be modified in substance and/or in order, one or more steps of the method 80 may not be followed, or one or more additional steps may be added.

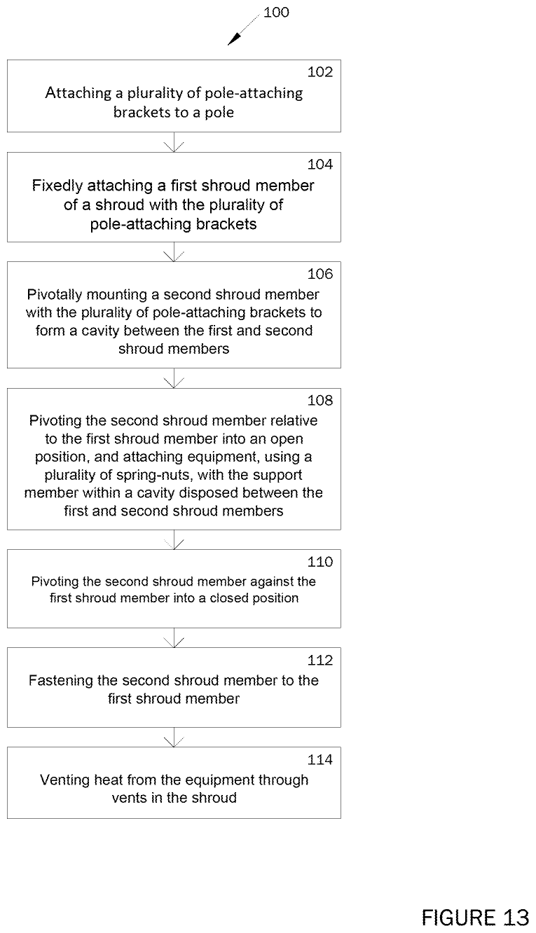

FIG. 13 illustrates a flowchart of one embodiment of a method 100 of attaching or using an apparatus. The method 100 may utilize any of the apparatus of the disclosure. In other embodiments, the method 100 may utilize varying apparatus. Step 102 comprises attaching a plurality of pole-attaching brackets to a pole. Step 104 comprises fixedly attaching a first shroud member of a shroud with the plurality of pole-attaching brackets. Step 106 comprises pivotally mounting a second shroud member with the plurality of pole-attaching brackets to form a cavity between the first and second shroud members. Step 108 comprises pivoting the second shroud member relative to the first shroud member into an open position, and attaching equipment, using a plurality of spring-nuts, with the support member within a cavity disposed between the first and second shroud members. In one embodiment, step 108 comprises attaching equipment with a plurality of U-shaped, longitudinally-extending members attached to the support member, wherein opposed ends of each U-shaped, longitudinally-extending member curve inwardly, using a plurality of spring-nuts. In another embodiment, step 108 further comprises adjusting a vertical position of the equipment along the U-shaped, longitudinally-extending members by compressing the plurality of spring-nuts, moving the equipment along the U-shaped, longitudinally-extending members, and extending the plurality of spring-nuts to reattach the equipment. In still another embodiment, step 108 further comprises extending an equipment wire through a hole in the support member. Step 110 comprises pivoting the second shroud member against the first shroud member into a closed position. Step 112 comprises fastening the second shroud member to the first shroud member. Step 114 comprises venting heat from the equipment through vents in the shroud.

In other embodiments, one or more steps of the method 100 may be modified in substance and/or in order, one or more steps of the method 100 may not be followed, or one or more additional steps may be added.

One or more embodiments of the disclosure may have one or more of the following advantages: side-to-side adjustability of the apparatus to conform to leaning poles; front-to-back adjustability of the apparatus to conform to leaning poles; pre-drilled holes in the apparatus allow for wiring to be routed through to allow for concealment; the apparatus may be made of any type of material such as steel, aluminum, or other materials such as those used in the 3D printing industry such as polymers, nylon, etc.; reduced installation time of the apparatus to the pole by eliminating the need for field drilling to attach the apparatus; increased flexibility and time-efficiency of equipment change-outs or relocations due to the U-shaped, longitudinally-extending members; the shroud allows for concealment of the equipment in an aesthetically pleasing manner while allowing easy access to the equipment when needed; the shroud allows for ventilation of the equipment; and/or providing one or more other advantages.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. An apparatus for attaching equipment to a pole, the apparatus comprising:
a plurality of pole-attaching brackets;
a support member connected with and between the plurality of pole-attaching brackets, the support member adjustable towards and away from the plurality of pole-attaching brackets; and
a plurality of U-shaped, longitudinally-extending members attached to the support member, opposed ends of each U-shaped, longitudinally-extending member curved inwardly.

2. The apparatus of claim 1 wherein the plurality of pole-attaching brackets each comprise a U-shaped bracket.

3. The apparatus of claim 2 wherein each U-shaped bracket comprises a slot extending longitudinally between opposed surfaces of the U-shaped bracket.

4. The apparatus of claim 3 wherein the support member comprises a hole disposed in alignment with the slot of each U-shaped bracket.

5. The apparatus of claim 1 wherein the support member is C-shaped.

6. The apparatus of claim 6 further comprising opposed members connecting the support member to the plurality of pole-attaching brackets.

7. The apparatus of claim 6 wherein the opposed members collectively comprise a plurality of longitudinally-extending slots disposed in alignment with a plurality of holes of the plurality of pole-attaching brackets

8. The apparatus of claim 1 wherein the support member comprises a wire-run hole disposed between the plurality of U-shaped, longitudinally-extending members.

9. The apparatus of claim 1 further comprising a shroud connected with the plurality of pole-attaching brackets, the shroud comprising a first shroud member fixedly attached with the plurality of pole-attaching brackets, a second shroud member pivotally mounted with the plurality of pole-attaching brackets and configured to move between a closed position against the first shroud member and an open position disposed apart from the first shroud member, and a cavity disposed between the first and second shroud members.

10. The apparatus of claim 9 wherein the shroud further comprises a securement member configured to fasten the second shroud member to the first shroud member.

11. The apparatus of claim 9 wherein the shroud comprises a plurality of vents.

12. An apparatus for attaching equipment to a pole, the apparatus comprising:
a plurality of pole-attaching brackets; and
a shroud connected with the plurality of pole-attaching brackets, the shroud comprising a first shroud member fixedly attached with the plurality of pole-attaching brackets, a second shroud member pivotally mounted with the plurality of pole-attaching brackets and configured to move between a closed position against the first shroud member and an open position disposed apart from the first shroud member, and a cavity disposed between the first and second shroud members.

13. The apparatus of claim 12 wherein the shroud further comprises a securement member configured to fasten the second shroud member to the first shroud member.

14. The apparatus of claim 12 wherein the shroud comprises a plurality of vents.

15. A method of attaching or using an apparatus comprising:
attaching a plurality of pole-attaching brackets to a pole;
adjusting the plurality of pole-attaching brackets laterally relative to the pole while attached to the pole; and
adjusting a support member, connected with and between the plurality of pole-attaching rackets, towards and away from the plurality of pole-attaching brackets.

16. The method of claim 15 wherein the attaching the plurality of pole-attaching brackets to the pole comprises, for each of the plurality of pole-attaching brackets, inserting a fastener through a hole in the pole and through a longitudinally-extending slot in the pole-attaching bracket.

17. The method of claim 16 wherein the adjusting the plurality of pole-attaching brackets laterally relative to the pole while attached to the pole comprises, for each of the plurality of pole-attaching brackets, sliding the longitudinally-extending slot along the fastener.

18. The method of claim 15 further comprising, for each of the pole-attaching brackets, inserting fasteners through longitudinally-extending slots in opposed members connected to the support member and through holes in the pole-attaching bracket.

19. The method of claim 18 wherein the adjusting the support member, connected with and between the plurality of pole-attaching brackets, towards and away from the plurality of pole-attaching brackets comprises, for each of the pole-attaching brackets, sliding the longitudinally-extending slots along the fasteners.

20. The method of claim 15 further comprising attaching equipment with a plurality of U-shaped, longitudinally-extending members attached to the support member, wherein opposed ends of each U-shaped, longitudinally-extending member curve inwardly, using a plurality of spring-nuts.

21. The method of claim 20 further comprising adjusting a vertical position of the equipment along the U-shaped, longitudinally-extending members by compressing the plurality of spring-nuts, moving the equipment along the U-shaped, longitudinally-extending members, and extending the plurality of spring-nuts to reattach the equipment.

22. The method of claim 15 further comprising extending an equipment wire through a hole in the support member.

23. The method of claim 15 further comprising attaching a shroud with the plurality of pole-attaching brackets.

24. The method of claim 23 further comprising, after attaching the shroud with the plurality of pole-attaching brackets, pivoting a second shroud member of the shroud relative to a first shroud member of the shroud into an open position, and attaching equipment, using a plurality of spring-nuts, with the support member within a cavity disposed between the first and second shroud members.

25. The method of claim 24 further comprising, after attaching the equipment with the support member, pivoting the second shroud member against the first shroud member into a closed position.

26. The method of claim 25 further comprising, after pivoting the second shroud member against the first shroud member into the closed position, fastening the second shroud member to the first shroud member.

27. The method of claim 26 further comprising, after fastening the second shroud member to the first shroud member, venting heat from the equipment through vents in the shroud.

28. A method of attaching or using an apparatus comprising:
attaching a plurality of pole-attaching brackets to a pole;
fixedly attaching a first shroud member of a shroud with the plurality of pole-attaching brackets; and
pivotally mounting a second shroud member with the plurality of pole-attaching brackets to form a cavity between the first and second shroud members.

29. The method of claim 28 further comprising pivoting the second shroud member relative to the first shroud member into an open position and attaching equipment within the cavity.

30. The method of claim 29 wherein the attaching equipment within the cavity comprises vertically adjusting a position of the equipment along a plurality of U-shaped, longitudinally-extending members attached to a support member within the cavity, wherein opposed ends of each U-shaped, longitudinally-extending member curve inwardly, and attaching the equipment with the plurality of U-shaped, longitudinally-extending members using a plurality of spring-nuts.

31. The method of claim 29 further comprising extending an equipment wire through a hole in a support member between the first and the second shroud.

32. The method of claim 29 further comprising, after attaching the equipment within the cavity, pivoting the second shroud member relative to the first shroud member into a closed position.

33. The method of claim 32 further comprising, after pivoting the second shroud member into the closed position, fastening the second shroud member to the first shroud member.

34. The method of claim 33 further comprising, after fastening the second shroud member to the first shroud member, venting heat from the equipment through vents in the shroud.
